(19) United States
(12) Patent Application Publication
(10) Pub. No.: US 2022/0155913 A1
(43) Pub. Date: May 19, 2022

(54) ACCESSING ITEM INFORMATION FOR AN ITEM SELECTED FROM A DISPLAYED IMAGE

(71) Applicants: Sony Group Corporation, Tokyo (JP); Sony Pictures Entertainment Inc., Culver City, CA (US)

(72) Inventor: Don C. Eklund, II, Yorba Linda, CA (US)

(21) Appl. No.: 17/589,455

(22) Filed: Jan. 31, 2022

Related U.S. Application Data
(63) Continuation of application No. 12/722,300, filed on Mar. 11, 2010, now abandoned.
(60) Provisional application No. 61/159,362, filed on Mar. 11, 2009.

(51) Int. Cl. G06F 3/0481; G06F 16/432

(52) U.S. Cl. CPC G06F 3/0481; G06F 3/14; G06F 16/434

(57) ABSTRACT

Accessing item information for items selected from an image including: presenting an image including a plurality of selectable items for selection by a viewer; determining a position of an item selected from the plurality of selectable items by the viewer; sending the determined position of an item along with timing information of the image to a server; receiving information related to the item selected by the viewer from the server, wherein the information related to the item was retrieved by the server from a database using the determined position of an item and the timing information of the image; and presenting the information related to the item.

### CROSS-REFERENCE TO RELATED APPLICATIONS

This application is a continuation application of co-pending U.S. patent application Ser. No. 12/722,300 (filed Mar. 11, 2010), which claimed the benefit of priority under 35 U.S.C. § 119(e) of U.S. Provisional Patent Application No. 61/159,362 (filed Mar. 11, 2009). The disclosures of the above-referenced applications are incorporated herein by reference.

### BACKGROUND

### Field of the Invention

The present invention relates to items displayed on an image, and more specifically, to accessing information for items selected from the displayed image.

### Background

The rapid increase in consumer demand for consumer technology has prompted an exponential growth in the number of available video programs communicated across broadcast networks, satellite, cable, and the Internet. However, obtaining information about items presented in the video programs and movies is difficult. For example, to find out about an actor appearing in a movie, the viewer may need to find the actor's name from the credit information at the end of the movie, and then search the Internet for any particular information about the actor. Although interactive programs may allow the viewer to click on the actor while viewing the movie to get information about that actor, the number items that are available for obtaining detailed information about items in the displayed image may be limited.

### SUMMARY

The present invention provides for accessing information for item(s) selected from a displayed image.

In one implementation, a method of accessing item information for items selected from an image is disclosed. The method includes: presenting an image including a plurality of selectable items for selection by a viewer; determining a position of an item selected from the plurality of selectable items by the viewer; sending the determined position of an item along with timing information of the image to a server; receiving information related to the item selected by the viewer from the server, wherein the information related to the item was retrieved by the server from a database using the determined position of an item and the timing information of the image; and presenting the information related to the item.

In another implementation, a method of providing item information for items selected from an image is disclosed. The method includes: receiving position information of an item selected from a plurality of items displayed on the image, along with timing information of the image from a client media device; determining information related to the selected item of the image using the position information and the timing information, wherein the image represents a single frame of multi-frame media, and wherein the position information is used to identify the selected item, and the timing information is used to identify a selected frame of the multi-frame media.

In another implementation, a system for accessing item information for items selected from a displayed image is disclosed. The system includes: a client media device to present media including a plurality of images, each image of the plurality of images including selectable items, the client media device enabling a viewer to select at least one item of the selectable items, wherein when the viewer selects the at least one item, the client media device determines and sends position information of the at least one item within one image of the plurality of images, along with timing information of the one image; and a server to receive the position information and the timing information, and determine which item on which image of the plurality of images corresponds to the received position information and timing information, wherein the server retrieves and sends back to the client media device, relevant information corresponding to the at least one item matching the position information and the timing information.

In another implementation, a client media apparatus is disclosed. The apparatus includes: means for presenting an image including a plurality of selectable items for selection by a viewer; means for determining a position of an item selected from the plurality of selectable items by the viewer; means for sending the determined position of an item along with timing information of the image to a server; means for receiving information related to the item selected by the viewer from the server, wherein the information related to the item was retrieved by the server from a database using the determined position of an item and the timing information of the image; and means for presenting the information related to the item.

In another implementation, a server apparatus is disclosed. The apparatus includes: means for receiving position information of an item selected from a plurality of items displayed on an image, along with timing information of the image from a client media device; and means for determining information related to the selected item of the image using the position information and the timing information, wherein the image represents a single frame of multi-frame media, and wherein the position information is used to identify the selected item, and the timing information is used to identify a selected frame of the multi-frame media.

In yet another implementation, a computer-readable storage medium storing a computer program for accessing item information for items selected from an image is disclosed. The computer program includes executable instructions that cause a computer to: present an image including a plurality of selectable items for selection by a viewer; determine a position of an item selected from the plurality of selectable items by the viewer; send the determined position of an item along with timing information of the image to a server; receive information related to the item selected by the viewer from the server, wherein the information related to the item was retrieved by the server from a database using the determined position of an item and the timing information of the image; and present the information related to the item.

In a further implementation, a computer-readable storage medium storing a computer program for providing item information for items selected from an image is disclosed. The computer program includes executable instructions that cause a computer to: receive position information of an item selected from a plurality of items displayed on the image, along with timing information of the image from a client media device; determine information related to the selected item of the image using the position information and the timing information, wherein the image represents a single frame of multi-frame media, and wherein the position information is used to identify the selected item, and the timing information is used to identify a selected frame of the multi-frame media.

Other features and advantages of the present invention will become more readily apparent to those of ordinary skill in the art after reviewing the following detailed description and accompanying drawings.

### BRIEF DESCRIPTION OF THE DRAWINGS

FIG. 1 shows a system for accessing item information for items selected from an image displayed by a network-connected media player in accordance with one implementation of the present invention.

FIG. 2 shows a process of selecting an item on a displayed image by directing a cursor over or near the item.

FIG. 3 is a flowchart illustrating a process for accessing item information for items selected from an image in accordance with one implementation of the present invention.

### DETAILED DESCRIPTION

Implementations as disclosed herein provide for accessing information for item(s) selected from a displayed image. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

In one implementation, item information is accessed for item(s) selected from image(s) displayed by a network-connected media player. The image can be one frame of image within a movie. The media player can include an interface (e.g., including a controller) that allows a user to select or indicate item(s) of interest on the displayed image using display position information. For example, an item on a displayed image is selected by directing a cursor over or near the item. The media player determines the position information of the cursor within the displayed image. In one case, the position information is resolved into an x-y coordinate system. In another case, the position information is resolved into a pixel coordinate system.

The media player sends the determined position information along with a current time, a frame number of the displayed image, and other information about the displayed image and/or the selected item(s) to a network server, for example. In one implementation, the network server determines what selected item(s) are at or near the position information in the displayed image identified by the current time, frame number, and other information. The network server then sends information related to the selected item(s) back to the media player. In one implementation, the position information includes X and Y coordinates of the item(s) selected by an interface, which may include a controller.

In one example, a person watching a movie on a television presented from a Blu-ray Disc (BD) player can use the remote control of the television or BD player to select item(s) displayed on the television screen. The BD player (e.g., by communicating with a server including a database) determines which item(s) has been selected based on comparing x and y coordinates of an on-screen cursor and a database (e.g., on a network server) linking coordinates and frames. The BD player then retrieves information related to the selected item(s) from the database.

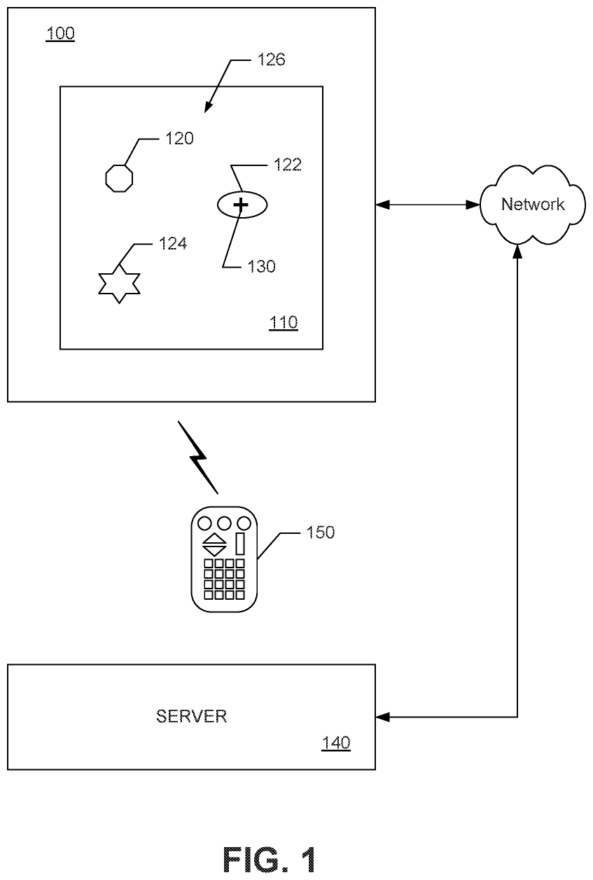

FIG. 1 shows a system for accessing item information for items 120, 122, 124 selected from an image 110 displayed by a network-connected media player 100 in accordance with one implementation of the present invention. In one example, the image 110 can be one frame of image within a movie, which is being displayed by the media player 100. The media player 100 can also include an interface (including a remote control 150) that allows a user to select or indicate item(s) of interest 122 on the displayed image 110 using display position information.

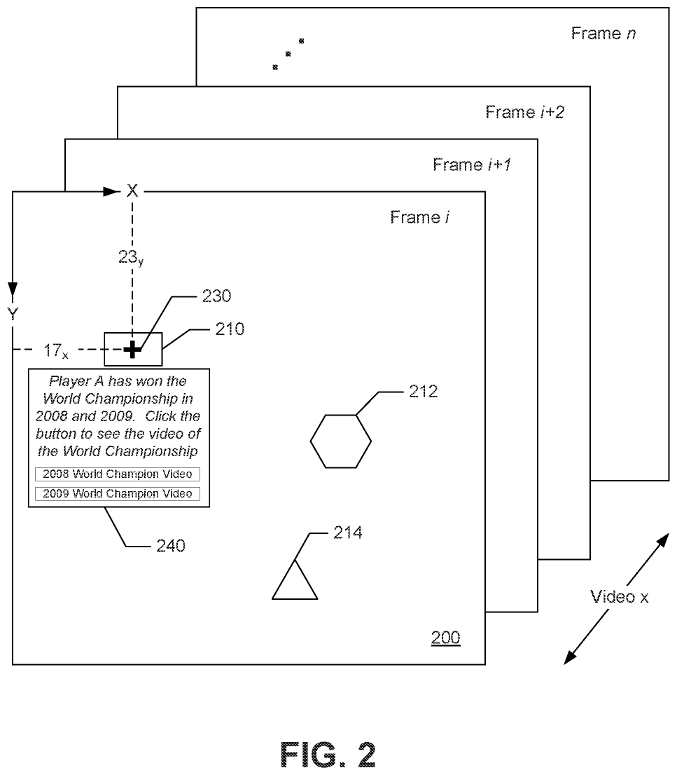

For example, as shown in FIG. 2, an item 210 on a displayed image 200 is selected by directing a cursor 230 (e.g., controlled by a remote control 150) over or near the item 210. As shown, the displayed image 200 also includes other non-selected items 212, 214. In other examples, area(s) 126 (of FIG. 1) that is not occupied by any items can be selected using the cursor 130.

As stated above, the image 200 can be one frame of a movie (e.g., Frame i) within a movie (e.g., Movie x) having a plurality of frames (e.g., Frames i, i+1, i+2, . . . , n). The position information of the cursor 230 within the displayed image 200 is determined by the media player. In the illustrated example, the position information of the cursor 230 is resolved into an x-y coordinate system, wherein the x position is 17 and the y position is 23.

Referring again to FIG. 1, once the position information of the cursor is determined, the media player 100 sends the determined position information along with a current time, a frame number of the displayed image, and other information about the displayed image to a network server 140, for example. The network server 140 then determines which item(s) are at or near the position information on the displayed image identified by the current time, frame number, and other information. In one implementation, the network server 140 sends information related to or describing the selected item 122 back to the media player 100. In another implementation, the information related to the selected item 122 is locally stored on the media player 100. In this case, the network server 140 sends a reference indicator of the related information stored on the media player 100.

In one implementation, the retrieved information related to the selected item 122 is stored as one or more tables and/or databases of information. For example, an item table stored in the network server 140 includes information 240 corresponding to an x-y coordinate range (14 to 23, 22 to 27) for Frame i in Movie x. Thus, when the cursor x-y coordinate (17, 23), along with the current time and/or the frame number, is sent to the network server 140, the network server 140 receives and processes the information from the media player 100. The network server 140 then retrieves from the item table, information 240 corresponding to the x-y coordinate range (14 to 23, 22 to 27), which includes the cursor x-y coordinate (17, 23), and sends that information 240 to the media player 100. The retrieved information 240 can be stored locally or remotely (e.g., across a network). Further, the retrieved information 240 is displayed locally. In one implementation, as shown in FIG. 2, the retrieved information 240 is displayed on the same display 200 in which the image including the selectable items 210, 212, 214 were displayed. In another implementation, the retrieved information is displayed on a display separate from the display 200.

In another implementation, the item table may indicate that the x-y coordinate range (14 to 23, 22 to 27) of Frame i corresponds to Player A. Further, the media player can store information indicating where an item database corresponding to the item table can be accessed to retrieve information for selected items.

In example operation, a user causes a BD player to play a movie, presenting the images of the movie on a television screen connected to the BD player. The user selects an item (e.g., Player A) on the screen using a remote control (e.g., by moving a cursor to a location on the screen using arrow buttons and pressing a select button to confirm the location). The BD player records the location and the time and/or frame number of the selection (or derives the frame number from the time). The BD player accesses the item table and retrieves an entry (e.g., indicating Player A) corresponding to the selected location and time/frame number. The BD player then accesses the item database to retrieve information for the item (e.g., Player A's statistics). Depending on the implementation, either or both the item table and the item database can be in various locations (separately or together), such as stored on the BD, in the BD player, in local storage (e.g., a storage device connected to the BD player or on a home network), or in remote storage (e.g., a network server across the internet). For example, in one implementation, a first remote database is accessed to identify the movie on the BD, a second remote database is accessed to retrieve or access the item table, and a third remote database is accessed to query the item database. After receiving the item information, the BD player presents the information to the user on the television screen.

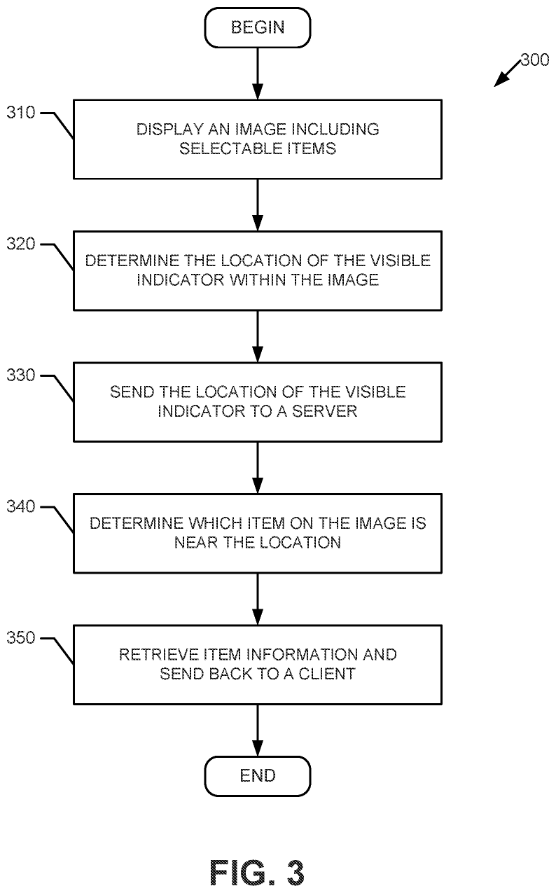

FIG. 3 is a flowchart 300 illustrating a process for accessing item information for items selected from an image in accordance with one implementation of the present invention. Initially, an image including a plurality of selectable items is displayed, at box 310, for selection by a user. In one implementation, the item can be selected by directing a cursor over or near the item. The image which displays the selectable items can be a single frame within a movie or video. Location of the selected item within the displayed image is then determined, at box 320. In one implementation, the location of the selected item is determined by determining the x-y position of the cursor. Once the location of the selected item is determined, this information, along with a current time, a frame number of the displayed image, and other information about the displayed image (e.g., which movie or video), is transmitted, at box 330, from a client to a server.

At box 340, the server determines which item is at or near the received location of the frame number in the selected movie. Once the item has been determined, at box 340, information related to the determined item is retrieved and transmitted back to the client, at box 350. In one implementation, the retrieved information related to the selected item is stored as one or more tables and/or databases of information.

Summary of implementations includes various methods, systems, apparatus, and storage media. In one implementation, a method of accessing item information for items selected from an image is disclosed. The method includes: presenting an image including a plurality of selectable items for selection by a viewer; determining a position of an item selected from the plurality of selectable items by the viewer; sending the determined position of an item along with timing information of the image to a server; receiving information related to the item selected by the viewer from the server, wherein the information related to the item was retrieved by the server from a database using the determined position of an item and the timing information of the image; and presenting the information related to the item. In this implementation: a position of an item is determined by determining a position of a cursor moved over the item by the viewer; the image represents a single frame of a video; the timing information of the image includes a frame number of the single frame within the video.

In another implementation, a method of providing item information for items selected from an image is disclosed. The method includes: receiving position information of an item selected from a plurality of items displayed on the image, along with timing information of the image from a client media device; determining information related to the selected item of the image using the position information and the timing information, wherein the image represents a single frame of multi-frame media, and wherein the position information is used to identify the selected item, and the timing information is used to identify a selected frame of the multi-frame media. In this implementation, information related to the selected item is determined by: identifying the selected frame and the selected item; and retrieving the information related to the selected item by searching database entry corresponding to the identified frame and item. The information related to the selected item can be further determined by sending the retrieved information related to the selected item to the client media device.

In another implementation, a system for accessing item information for items selected from a displayed image is disclosed. The system includes: a client media device to present media including a plurality of images, each image of the plurality of images including selectable items, the client media device enabling a viewer to select at least one item of the selectable items, wherein when the viewer selects the at least one item, the client media device determines and sends position information of the at least one item within one image of the plurality of images, along with timing information of the one image; and a server to receive the position information and the timing information, and determine which item on which image of the plurality of images corresponds to the received position information and timing information, wherein the server retrieves and sends back to the client media device, relevant information corresponding to the at least one item matching the position information and the timing information. In this implementation: the client media device includes an interface to enable the viewer to select the at least one item by using a remote control to move a cursor near the at least one item; the position information of the at least one item includes an x-y coordinate of the at least one item within the one image of the plurality of images; the plurality of images comprises a video; the timing information of the one image includes a timing indication of the one image within the video; the timing indication is a frame number of the video; the server includes an item table for the video, the item table having entries including the position information, the timing information, and an identifier for at least one item, wherein the server retrieves the identifier corresponding to the received position information and the timing information; the server further includes an item database for the video, the item database having entries including the identifier and corresponding relevant information, wherein the server retrieves the relevant information corresponding to the retrieved identifier, and sends the retrieved relevant information to the client media device; and the client media device includes a Blu-ray Disc (BD) player.

The descriptions of the disclosed implementations are provided herein to enable any person skilled in the art to make or use the invention. Numerous modifications and variations to these implementations would be readily apparent to those skilled in the art, and the principals defined herein can be applied to other implementations without departing from the spirit or scope of the invention. For example, although the specification describes using x-y coordinates to identify the location of the selected item(s), other methods such as visible hot spots can be used to identify the location. Other variations may include: (1) the cursor is caused to jump or snap to or rotate among hot spots or objects; (2) rather than selecting an item exactly on the selected location, a nearest item of interest to the selected location is selected; (3) the retrieved item information includes actor information, location information, and/or product information; (4) the retrieved item information is presented as text, audio, and/or video; (5) the content (e.g., video) is stored on BD, DVD, HD-DVD, tape, or hard disk drives; and (6) the content is streaming content from a network location. Thus, the invention is not intended to be limited to the implementations shown herein but is to be accorded the widest scope consistent with the principal and novel features disclosed herein.

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a computer-readable storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. (canceled)

2. A method of accessing item information for items selected within a video, the method comprising:
presenting the video on a television to a viewer using a video player, wherein each frame of the video includes a plurality of selectable items for selection by the viewer such that the viewer selects an item from the plurality of selectable items within a frame of the video;
determining a position of the selected item and the frame of the video along with timing information of the frame of the video;
accessing a first remote database to identify the video with a name of the video;
accessing a second remote database to retrieve an item table for the video having entries including the positions of the items having x-y coordinate ranges, frame numbers, and identifiers for the plurality of selectable items;
determining an identifier for the selected item in the frame of the video by comparing the timing information of the frame to the frame numbers and the position of the selected item to the x-y coordinate ranges in the item table retrieved by the second remote database,
wherein the determined identifier for the selected item is one of the identifiers stored in the item table;
accessing a third remote database to query an item database and retrieve relevant information corresponding to the determined identifier; and
presenting the relevant information corresponding to the selected item to the viewer on a display.

3. The method of claim 2, wherein determining a position of the selected item comprises determining a position of a cursor moved over an item of the plurality of selectable items by the viewer.

4. The method of claim 2, wherein the frame represents a single frame of the video.

5. The method of claim 4, wherein the timing information of the frame includes a frame number of the single frame within the video.

6. A method of providing item information for items selected from a frame of multi-frame media, the method comprising:
receiving position information of an item selected from a plurality of items displayed on the frame of the multi-frame media, along with timing information of the frame from a client media device, wherein the position information of the item refers to a position of the selected item in the frame of the multi-frame media;
accessing a first remote database to identify the multi-frame media with a name;
accessing a second remote database to retrieve an item table for the multi-frame media having entries including position information of items having x-y coordinate ranges, frame numbers, and identifiers for the items;
selecting an identifier for the selected item from the identifiers in the item table corresponding to the name of the multi-frame media, the timing information, and the position information from the item table retrieved by the second remote database;
accessing a third remote database to query an item database for the multi-frame media to retrieve relevant information corresponding to the identifier retrieved from the second remote database; and
sending the retrieved relevant information to the client media device.

7. The method of claim 6, wherein accessing the second remote database to retrieve an item table comprises:
identifying a selected frame from the timing information and a selected x-y coordinate range from the position of the selected item.

8. The method of claim 7, wherein accessing the second remote database to retrieve an item table further comprises
comparing the selected frame and the selected x-y coordinate range to the frame numbers and x-y coordinate ranges in the item table.

9. A system for accessing item information for items selected from a displayed frame of media, the system comprising:
first, second, and third remote databases;
a client media device configured to present the media including a plurality of frames, wherein each frame of the plurality of frames includes selectable items for selection by a viewer,
the client media device configured to enable the viewer to select at least one item of the selectable items,
the client media device also configured to access the first remote database to determine a name of the media,
wherein when the viewer selects the at least one item, the client media device determines and sends the name of the media, position information of the at least one selected item within the displayed frame of the media, timing information of the displayed frame within the media; and
a server configured to receive the name of the media, the position information, and the timing information from the client media device,
the server configured to access the second remote database to retrieve an item table for the media having entries including x-y coordinate ranges, frame numbers, names of the media, and identifiers corresponding to the x-y coordinate ranges,
the server also configured to retrieve an item identifier corresponding to the at least one selected item by comparing the name of the media, the timing information, and the position information to the entries in the item table, wherein the retrieved item identifier is one of the identifiers stored in the item table,
the server also configured to access the third remote database to retrieve an item database for the media, the item database having entries including item identifiers and corresponding relevant information,
the server further configured to retrieve and send the relevant information corresponding to the retrieved item identifier to the client media device by comparing the retrieved item identifier to the entries in the item database; and
wherein the client media device receives and displays the relevant information corresponding to the at least one item near the at least one item in the displayed frame of the media.

10. The system of claim 9, wherein the client media device includes
an interface to enable the viewer to select the at least one item by using a remote control to move a cursor near the at least one item.

11. The system of claim 9, wherein the position information of the at least one item includes
an x-y coordinate of the at least one item within the displayed frame of the media.

12. The system of claim 9, wherein the plurality of frames comprises a video.

13. The system of claim 12, wherein the timing information of the displayed frame includes a timing indication of where the displayed frame is placed within the media.

14. The system of claim 13, wherein the timing indication is a frame number of the displayed frame within the media.
